(19) United States
(12) Patent Application Publication
(10) Pub. No.: US 2002/0107727 A1
(43) Pub. Date: Aug. 8, 2002

(54) Method of recording and reporting consumer interaction with a digital publication

(75) Inventor: Donald E. Traub, Daytona Beach, FL (US)

Correspondence Address: Paul S. Rooy, 2620 S. Peninsula Dr., Daytona Beach, FL, 32118, US

(73) Assignee: Diskmailer, Inc.

(21) Appl. No.: 09/776,148

(22) Filed: Feb. 5, 2001

(51) Int. Cl. G06F 17/60

(52) U.S. Cl. 705/14; 705/10

(57) ABSTRACT

A method of recording and reporting consumer interaction with a digital publication. The method of recording and reporting consumer interaction with a digital publication comprises the steps of advertisers submitting content to a surveyor, the surveyor incorporating the content submitted into a digital publication stored on a digital medium, sending the digital publication to consumers, consumers browsing the digital publication on consumer computers connected to a surveyor server via an internet, and consumer interaction histories being reported to the advertisers. The surveyor may send reports to the advertisers, either upon request by the advertisers or periodically as ordered by the advertisers. Each report may include a report identification section, a timeframe & quantity section, a map section, a response rates section, a usage rates section, and a spreadsheet button. Major advantages of the instant method of recording and reporting consumer interaction with a digital publication include real-time transparent reporting of consumer interactions and purchases, detailed interactions reporting including length of time spent in each digital publication section, and customizable reports to meet the needs of specific advertisers.

### BACKGROUND OF THE INVENTION

1. Field of the Invention

This invention relates to surveying consumer interaction with advertising in a publication, and in particular to a method of recording and reporting consumer interaction with a digital publication.

2. Background of the Invention

Advertising in publications has become well-established during the last few hundred years. Traditionally, an advertiser places an ad in a print medium such as a magazine or a direct mail piece, and then waits to see how many responses he gets indicating interest, and ultimately how many purchases are made in response to the original ad.

The above model has prevailed for many years, and presents significant problems in the assessment of ad effectiveness. One problem is the difficulty in directly measuring how actual consumers react to a given advertisement. The indirect measure is the buy rate based on the advertisement, but this is an imprecise tool. The advertiser has no way of knowing what section(s) of the advertisement encouraged the buy decision, nor if some sections of the ad actually discouraged the decision to purchase. Unanswered questions remain such as: How much time did consumers spend in each section of the ad? What type of information did consumers appear to want more of? What ad sections received little or no attention, and should be deleted from future ads? If an audio and/or visual section was included in the ad, how many times did the average consumer play the audio and/or visual section?

Indirect answers to these questions could be obtained from focus groups and test marketing, but in the end the results from this type of data were necessarily indirect, because the actual buyers were not surveyed—only simulated buyers were canvassed. The survey group members knew they were participating in a survey, and this knowledge affected their behavior. Thus, it would be desirable to obtain data from actual consumers going through the buying decision (or, possibly equally informative, the decision not to buy) transparently, that is, without the consumers being constantly reminded that their actions are being recorded.

In the case of the test marketing tool, absent obtaining completed questionnaires (or other reporting device) from the buyers, the above questions remained unanswered, and the sample size is smaller than in the case of full scale marketing.

Another problem with conventional assessment of published advertising effectiveness is the time lag involved. It could be weeks (or even months) before all the responses to a given print ad are received, especially in the case of a printed magazine which could languish in a dentist's reception area years after publication. Therefore, it would be beneficial to receive real-time information as the consumers make their purchase decisions, so as to allow advertisers the time to refine their advertisements prior to the next publication date.

Still another problem with existing consumer response data gathering and presentation is the labor and time required to present the data in reader-friendly fashion. Translation of a stack of questionnaires into easy-to-interpret graphics takes time and labor. It would be desirable to provide a method of reporting consumer interaction with publications and advertising which automatically present data in formats friendly to the user, and even to provide the capability for advertisers to design their own presentation formats, and to have these presentation formats (such as graphs, bar charts, maps, spreadsheets, etc.) reflect real-time consumer interaction with advertising.

### SUMMARY OF THE INVENTION

Accordingly, it is an object of the present invention to provide a method of recording and reporting consumer interaction with a digital publication which records a consumer's interaction with a digital publication, including what sections the consumer has browsed, the time spent in each, the actions taken in each section, what audio and/or video selections have been played, how many times, and what purchases have been made. Method steps allowing this object to be accomplished include sending a digital magazine on a digital storage medium to consumers, consumers interacting with same in consumer computers, software storing consumer interaction histories in consumer computer random access memories, and consumer interaction histories being sent to a surveyor server via the internet or telephone lines. Advantages associated with the accomplishment of this object include the ability of advertisers to access each move a consumer makes while interacting with the digital publication, and to use this information to design more effective advertising.

It is another object of the present invention to provide a method of recording and reporting consumer interaction with a digital publication which provides advertisers with customizable user-friendly reporting. Method steps allowing this object to be accomplished include advertisers accessing their domains in a surveyor server by means of a unique advertiser password assigned to each advertiser, each advertiser requesting reports pertaining to his own advertising, customizing same as required, and the server supplying the reports requested to the appropriate advertiser. A benefit associated with the accomplishment of this object is fast, user-friendly reporting of consumer interaction with advertisements.

It is still another object of this invention to provide a method of recording and reporting consumer interaction with a digital publication which records and reports consumer interactions transparently, that is, without the consumer being constantly reminded that his interaction history is being recorded and reported. Design features enabling the accomplishment of this object include a digital publication which provides a sole reporting/recording “opt-out” screen at the beginning of a session, and no further reminders throughout the remainder of the session. Advantages associated with the realization of this object include more accurate and realistic data relating to consumer reaction to advertising.

It is another object of the present invention to provide a method of recording and reporting consumer interaction with a digital publication which provides real-time reporting of consumer reactions to a digital publication. Design features allowing this object to be accomplished include consumer computers connected to a surveyor server via an Intranet, and a digital publication which contains software which provides for transmission of consumer interaction histories to the surveyor server at pre-determined time intervals. Benefits associated with the accomplishment of this object include the ability of advertisers to quickly assess the effectiveness of their advertisements, and to have plenty of time to make refinements and changes to same before the next publication date of the digital publication.

It is another object of the present invention to provide a method of recording and reporting consumer interaction with a digital publication which provides user-friendly reports. Design features allowing this object to be accomplished include report formats provided by a surveyor server which include a timeframe and quantity section, a customizable map section which geographically depicts digital publication readership and purchase rates, a response rates section which graphically depicts purchases by product, and a usage patterns section which depicts consumer usage of the digital publication by day of the week and time of day. In addition, customizable spreadsheet reporting capability is provided, as well as response rate, purchase rate, and current estimated return on investment. Benefits associated with the accomplishment of this object include reduction in time and effort on the part of advertisers in understanding the response of consumers to their advertising.

### BRIEF DESCRIPTION OF THE DRAWINGS

The invention, together with the other objects, features, aspects and advantages thereof will be more clearly understood from the following in conjunction with the accompanying drawings.

Two sheets of drawings are provided. Sheet one contains FIG. 1. Sheet two contains FIG. 2.

FIG. 1 is a diagrammatic view of the instant method of recording and reporting consumer interaction with a digital publication.

FIG. 2 is a diagrammatic depiction of a typical Campaign Activity & Performance Overview Report.

### DETAILED DESCRIPTION OF THE PREFERRED EMBODIMENT

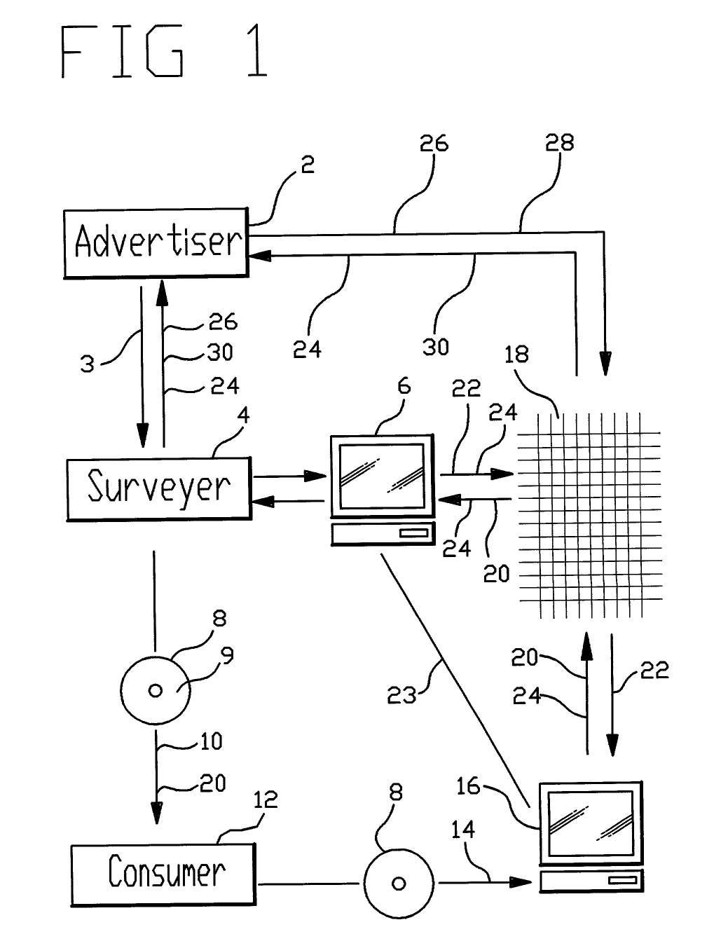

Referring now to FIG. 1, we observe a diagrammatic view of the instant method of recording and reporting consumer interaction with a digital publication. Advertiser 2 sends content 3 to surveyor 4. Surveyor 4 incorporates content 3 into digital publication 9, which is stored on digital storage medium 8. Digital storage medium 8 may be any appropriate digital storage medium, including but not limited to CD ROM, DVD, floppy disk, etc. Surveyor 4 direct mails digital storage medium 8 containing digital publication 9 to a targeted group of consumers 12 as indicated by arrow 10. Surveyor 4 also sends a unique consumer password 20 to each consumer 12, which identifies each consumer 12 for later reference.

For clarity and simplicity, FIG. 1 only depicts a single advertiser 2 and consumer 12; in practice one or many advertisers 2 contribute to each digital publication, and digital storage medium 8 is sent to many consumers 12.

To interact with digital publication 9, consumer 12 reads digital publication 9 on digital storage medium 8 on consumer computer 16, as indicated by arrow 14. Digital publication 9 comprises software which requests the entry of consumer password 20 upon initiation of the first session. Consumer password 20 is sent via internet 18 to surveyor server 6, which verifies consumer password 20 and sends session identification number 22 back to consumer computer 16.

At this point consumer 12 is free to browse digital publication 8. Digital publication 9 ranges in size anywhere from a single-advertiser digital brochure to a digital magazine containing content from many advertisers 2.

For example, where digital publication 9 is a digital magazine, digital publication 9 may comprise multimedia presentations by many advertisers 2, and contain software and services designed to save consumers 12 time and money. Different sections of digital publication 9 may contain entertaining content expressed through video, animation, music and sound to attract potential customers to an advertiser's products and services. Consumers 12 can interact with, and ultimately make purchases of advertised products, directly through digital publication 9. By clicking on different links contained in digital publication 9, consumers 12 can go directly to the web sites of advertisers 2.

Software contained in digital publication 9 tracks and records every move that each consumer 12 makes while interacting with digital publication 9. One of the opening screens of digital publication 9 permits consumer 12 to decline this tracking and reporting, if desired. If consumer 12 does not “opt out” of the recording and reporting of consumer interaction with digital publication 9, every action consumer 12 takes while interacting with digital publication 9 is thereafter recorded by software contained in digital publication 9, and stored in mass storage medium of consumer computer 16 (e.g. hard drive, zip drive, tape, etc.).

The history of consumer 12's interaction with digital publication 9 is consumer interaction history 24. Consumer interaction history 24 includes information such as session identification number 22, an identifier for each advertiser 2 whose material consumer 12 interacts with, object identifiers, event identifiers, sequence numbers, and time/date stamps.

Events may include such actions as reading, listening, purchasing, starting, stopping, and changing consumer 12 preferences. Objects include items being acted upon, and may include muting music, unmuting music, TOC to Quicken, TOC to Movies, TOC to Books, TOC to Games, TOC to Music, TOC to Hometown, TOC to Great Offers, TOC to Websites, TOC to Plug-ins, TOC to Contests, Nav to Home, Nav to Movies, Nav to Books, Nav to Games, Nav to Music, Nav to Hometown, Nav to Great Offers, Nav to Web Sites, Nav to Plug-ins, Nav to Contests, Nav to Articles, Nav to Quit, Nav to BOA, Nav to Quicken, Replay Intro, Music Vignette, Attractions List, In Theatres List, On Video List, On Cable List, etc.

Sequence numbers are generated by the digital publication 9 software at pre-determined time intervals, for example, every ten seconds. Sequence numbers become part of consumer interaction history 24, and aid in error checking: if a consumer interaction history 24 which is missing some sequence numbers is received at surveyor server 6, such absence would indicate missing data from that consumer identification history 24.

One or more time/date stamps are inserted into each consumer interaction history 24 at predetermined intervals. These serve to provide a time dimension to aid in interpretation of consumer interaction history 24.

Where consumer computer 16 is connected to surveyor server 6 by means of internet 18, upon passage of a pre-determined time lapse (e.g. every ten seconds) consumer interaction history 24 is transmitted to surveyor server 6. For example, where the time lapse is every ten seconds, every ten seconds an update of consumer interaction history 24 is transmitted to surveyor server 6. In addition, an event trigger may be embodied in software on digital publication 9 which provides for transmission of consumer interaction history 24 following a pre-determined number of events, e.g. every ten events.

Where consumer computer 16 is not connected to surveyor server 6 by means of internet 18, consumer interaction history 24 is stored in consumer computer 16 mass storage medium. Consumer interaction history 24 remains thus stored in consumer computer 16 mass storage medium until such time as consumer computer 16 is again connected to internet 18, at which time software in digital publication 9 automatically transmits the stored consumer interaction history 24 to surveyor server 6.

Where consumer computer 16 has no access to internet 18 but does have a modem and telephone line connection, digital publication 9 software provides prompts to permit consumer computer 16 to connect to surveyor server 6 by means of telephone line 23. Once consumer computer 16 is connected to surveyor server 6 by means of telephone line 23, consumer 12 can send a consumer password 20 to surveyor server 6 and surveyor server 6 can issue a session identification number 24 to consumer computer 16. Consumer 12 can then access internet 18 in order to fully use the capabilities of digital publication 9, and periodic updates of consumer interaction history 24 can be transmitted to surveyor server 6 via telephone line 23.

Surveyor 4 assigns an advertiser password 26 to each advertiser who places content 3 on digital publication 9, and assigns an associated advertiser domain on surveyor server 6. At any time a given advertiser 2 wishes to access up-to-the-minute information regarding consumer 12 interactions with that advertiser's content 3 on digital publication 9, such advertiser 2 contacts surveyor server 6, sends his assigned advertiser password 26 and one or more advertiser queries 28, and surveyor 4 allows advertiser 2 access to all consumer interaction histories 24 pertaining to such advertiser's content 3, as well as customizable reports 30 depicting same.

A major advantage to the instant method of recording and reporting consumer interaction with a digital publication is the great flexibility in providing advertiser 2 with reports 30 which are easy to interpret, and which contain the information which is relevant to each individual advertiser 2. In addition, software on surveyor server 6 provides the capability of extensive customization of reports 30 by advertisers 2.

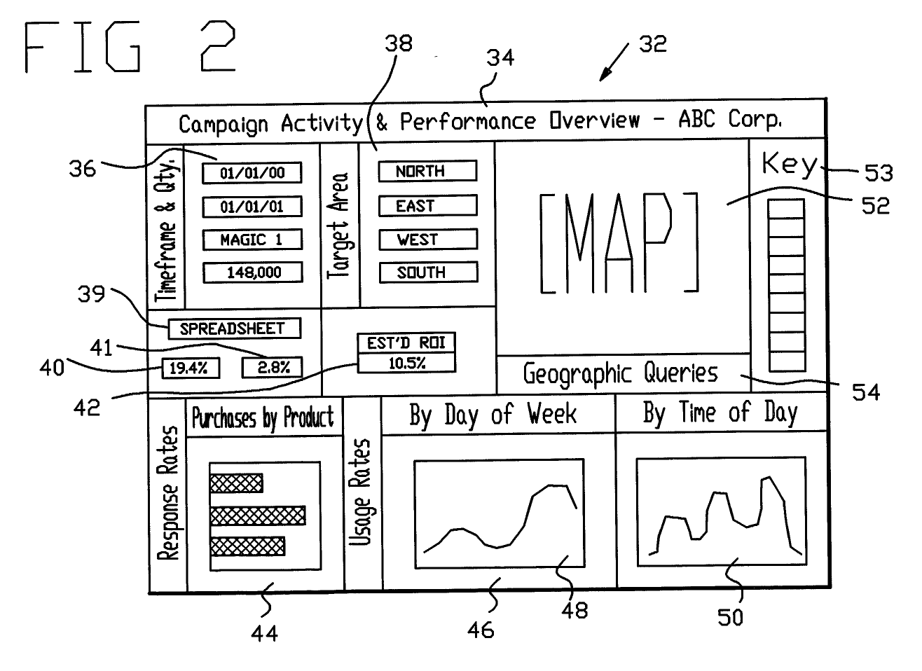

For example, overview report 32 is depicted in FIG. 2. FIG. 2 is a diagrammatic view of overview report 32 as it would appear on an advertiser's own computer screen. Overview report 32 comprises report identification section 34, timeframe & quantity section 36, target area section 38, map section 52, spreadsheet button 39, response rate 40, purchase rate 41, current estimated return on investment 42, response rates section 44, and usage rates section 46.

Report identification section 34 identifies overview report 32 as a summary report, and specifies which advertiser 2 the report pertains to. Timeframe & quantity section 36 contains the start and end dates which overview report 32 covers, campaign name, and total digital publication 9 distribution during that time period. Target area section 38 specifies the geographic area the data depicted in overview report 32 derives from, and is user-selectable.

Map section 52 graphically depicts response rate densities and/or purchase rate densities, as defined in key 53. Map section 52 contains geographic queries button 54. Clicking on geographic queries button 54 brings up a dialog box wherein an advertiser 2 can specify parameters to be mapped. For example, an advertiser 2 could request mapping of demographic information such as consumer educational level, age, marital status, income, etc. Alternately, an advertiser 2 could request mapping of consumer response information by geographical area such as viewership, purchases, etc. The geographical area definition can be narrowed to as small an area as a given street or neighborhood!

Clicking on spreadsheet button 39 brings up a dialog box wherein an advertiser 2 can specify one or more parameters to be depicted in spreadsheet form. For example, an advertiser 2 could request spreadsheet depiction of such information as purchases, viewership, profit margins on specific products offered for sale, total digital publication 9 distribution, cost per digital publication 9 to the advertiser 2, etc.

Response rate 40 shows the viewership of the advertiser's content 3. Purchase rate 39 shows the purchases of the advertiser's product line. Current estimated return on investment 42 depicts the estimated return on investment to the advertiser 2.

Response rates section 44 depicts purchases by products offered by advertiser 2. Usage rates section 46 comprises usage rates by day of week presentation 48, and usage by time of day presentation 50.

The instant method of recording and reporting consumer interaction with a digital publication comprises the following steps:

A. At least one advertiser submitting content to be included in a digital publication to a surveyor, said digital publication being published by said surveyor;

B. Said surveyor creating a digital publication stored on digital storage medium, said digital publication incorporating said content submitted by said at least one advertiser, said content being tagged with an advertiser identifier;

C. Sending said digital publication stored on said digital storage medium, and a unique consumer password, to at least one consumer;

D. Said at least one consumer interacting with said digital publication via a consumer computer reading said digital storage medium;

E. Said at least one consumer communicating said consumer password to a surveyor server by way of an internet;

F. Said surveyor server verifying said consumer password;

G. Said surveyor server sending a session identification number to said consumer computer by way of said internet;

H. Said consumer interacting with said digital publication by browsing at least one section of said digital publication, and taking at least one action in said at least one section;

I. A consumer interaction history being stored in mass storage medium in said consumer computer, said consumer interaction history comprising information including said session identification number, an identifier for each said advertiser, object identifiers, event identifiers, sequence numbers, and time/date stamps;

J. Upon passage of a pre-determined time lapse or upon completion of a pre-determined number of consumer actions; said consumer interaction history being transmitted to said surveyor server by way of said internet;

K. If said consumer computer is not connected to said internet during a given consumer interaction session, retaining said consumer interaction history stored in said consumer computer mass storage medium until such time as said consumer computer is again connected to said internet, and at that time transmitting said consumer interaction history to said surveyor server;

L. Said surveyor issuing an advertiser password to each said advertiser, and assigning an associated advertiser domain to each said advertiser;

M. One said advertiser sending an advertiser query to said surveyor server by way of said internet, said advertiser query including an advertiser password corresponding to the querying advertiser; and

N. Said querying advertiser receiving a portion of each said consumer interaction history wherein a consumer interacted with digital publication content tagged with said querying advertiser's identification number.

The instant method of recording and reporting consumer interaction with a digital publication may comprise the following optional steps:

O. Said surveyor sending said at least one advertiser periodic reports containing a portion of each said consumer interaction history wherein a consumer interacted with digital publication material tagged with said querying advertiser's identification number.

P. Said report comprising a geographical map showing digital publication mailing density.

Q. Said report comprising a geographical map showing consumer density of consumers interacting with a given advertiser's material.

R. Said report containing a map section, wherein an advertiser may define a geographical area depicted, and one or more parameters to be mapped.

S. Said report containing a spreadsheet section, wherein an advertiser may define one or more parameters to be depicted on a spreadsheet.

T. Said report comprising a breakdown of consumer interaction with each part of a given advertiser's material.

U. The instant method of recording and reporting consumer interaction with a digital publication where the above steps occur in real time.

V. Where a given consumer computer has no internet access, using a telephone line to connect said consumer computer to said server, whereby an interaction history of a consumer using said consumer computer to interact with said digital publication may be transmitted to said server.

While a preferred embodiment of the invention has been illustrated herein, it is to be understood that changes and variations may be made by those skilled in the art without departing from the spirit of the appending claims.

### DRAWING ITEM INDEX

2 advertiser

3 content

4 surveyor

6 surveyor server

8 digital storage medium

9 digital publication

10 arrow

12 consumer

14 arrow

16 consumer computer

18 internet

20 consumer password

22 session identification number

23 telephone line

24 consumer interaction history

26 advertiser password

28 advertiser query

30 report

32 overview report

34 report identification section

36 timeframe & quantity section

38 target area section

39 spreadsheet button

40 response rate

41 purchase rate

42 current estimated return on investment

44 response rates section

46 usage rates section

48 usage by day of week presentation

50 usage by time of day presentation

52 map section

53 key

54 geographical queries button

I claim:

1. A method of recording and reporting consumer interaction with a digital publication comprising the following steps:
A. At least one advertiser submitting content to be included in a digital publication to a surveyor, said digital publication being published by said surveyor;
B. Said surveyor creating said digital publication stored on a digital storage medium, said digital publication incorporating said content submitted by said at least one advertiser, said content being tagged with an advertiser identifier;
C. Sending said digital publication stored on said digital storage medium, and a unique consumer password, to at least one consumer;
D. Said at least one consumer interacting with said digital publication via a consumer computer reading said digital storage medium;
E. Said consumer interacting with said digital publication by browsing at least one section of said digital publication, and taking at least one action in said at least one section;
F. A consumer interaction history being stored in mass storage medium in said consumer computer, said consumer interaction history comprising information including a session identification number, at least one said advertiser identifier number, at least one object identifier, at least one event identifier, sequence numbers, and at least one time/date stamp;
G. Transmitting said consumer interaction history to a surveyor server;
H. At least one said advertiser sending an advertiser query to said surveyor server; and
I. Each said querying advertiser receiving a portion of each said consumer interaction history wherein a consumer interacted with said digital publication content tagged with said querying advertiser's identification number.

2. The method of recording and reporting consumer interaction with a digital publication of claim 1 wherein said consumer computer communicates with said surveyor server via an internet, and upon passage of a pre-determined time lapse or upon completion of a pre-determined number of consumer actions; said consumer interaction history is transmitted to said surveyor server by way of said internet.

3. The method of recording and reporting consumer interaction with a digital publication of claim 2 wherein if said consumer computer is not connected to said internet during a given consumer interaction session, said consumer interaction history is stored in said consumer computer mass storage medium until such time as said consumer computer is again connected to said internet, and at that time said consumer interaction history is transmitted to said surveyor server.

4. The method of recording and reporting consumer interaction with a digital publication of claim 1 wherein said consumer computer communicates with said surveyor server via modem and telephone line, and upon passage of a pre-determined time lapse or upon completion of a predetermined number of consumer actions; said consumer interaction history is transmitted to said surveyor server by way of said modem and telephone line.

5. The method of recording and reporting consumer interaction with a digital publication of claim 2 wherein if said consumer computer is not connected to said surveyor server by way of said modem and telephone line during a given consumer interaction session, said consumer interaction history is stored in said consumer computer mass storage medium until such time as said consumer computer is again connected to said surveyor server, and at that time said consumer interaction history is transmitted to said surveyor server.

6. The method of recording and reporting consumer interaction with a digital publication of claim 1 wherein the method steps occur in real time.

7. The method of recording and reporting consumer interaction with a digital publication of claim 1 wherein at least one said querying advertiser receives a report, said report comprising a report identification section and a timeframe and quantity section, said timeframe and quantity section comprising a campaign name, a start date, and an end date.

8. The method of recording and reporting consumer interaction with a digital publication of claim 7 wherein said report further comprises a map section showing consumer density of consumers interacting with a given advertiser's content on a map.

9. The method of recording and reporting consumer interaction with a digital publication of claim 7 wherein said report further comprises a map section showing mailing density of said digital publication on a map.

10. The method of recording and reporting consumer interaction with a digital publication of claim 8 wherein said map section further comprises a geographic queries button, whereby said querying advertiser may customize information depicted on said map.

11. The method of recording and reporting consumer interaction with a digital publication of claim 7 wherein said report further comprises a spreadsheet bottom, whereby an advertiser may define one or more parameters to be depicted on a spreadsheet.

12. The method of recording and reporting consumer interaction with a digital publication of claim 7 wherein said report further comprises a response rates section, wherein consumer purchases by product may be graphically depicted.

13. The method of recording and reporting consumer interaction with a digital publication of claim 7 wherein said report further comprises a usage rates section comprising a usage by day of week presentation and a usage by time of day presentation.

14. A method of recording and reporting consumer interaction with a digital publication comprising the following steps:
A. At least one advertiser submitting content to be included in a digital publication to a surveyor, said digital publication being published by said surveyor;
B. Said surveyor creating said digital publication stored on a digital storage medium, said digital publication incorporating said content submitted by said at least one advertiser, said content being tagged with an advertiser identifier;
C. Sending said digital publication stored on said digital storage medium, and a unique consumer password, to at least one consumer;
D. Said at least one consumer interacting with said digital publication via a consumer computer reading said digital storage medium;
E. Said at least one consumer communicating said consumer password to a surveyor server by way of an internet;
F. Said surveyor server verifying said consumer password;
G. Said surveyor server sending a session identification number to said consumer computer by way of said internet;
H. Said consumer interacting with said digital publication by browsing at least one section of said digital publication, and taking at least one action in said at least one section;
I. A consumer interaction history being stored in mass storage medium in said consumer computer, said consumer interaction history comprising information including said session identification number, an identifier for each said advertiser, at least one object identifier, at least one event identifier, sequence numbers, and at least one time/date stamp;
J. Upon passage of a pre-determined time lapse or upon completion of a pre-determined number of consumer actions; said consumer interaction history being transmitted to said surveyor server by way of said internet;
K. Said surveyor issuing an advertiser password to each said advertiser, and assigning an associated advertiser domain to each said advertiser;
L. One said advertiser sending an advertiser query to said surveyor server by way of said internet, said advertiser query including one said advertiser password corresponding to the querying advertiser; and
M. Said querying advertiser receiving a portion of each said consumer interaction history wherein a consumer interacted with digital publication content tagged with said querying advertiser's identification number.

15. The method of recording and reporting consumer interaction with a digital publication of claim 14 wherein if said consumer computer is not connected to said internet during a given consumer interaction session, said consumer interaction history is retained stored in said consumer computer mass storage medium until such time as said consumer computer is again connected to said internet, and at that time said consumer interaction history is transmitted to said surveyor server.

16. The method of recording and reporting consumer interaction with a digital publication of claim 15 wherein at least one said querying advertiser receives a report, said report comprising a report identification section, a timeframe and quantity section, a target area section, a map section, and a spreadsheet button.

17. The method of recording and reporting consumer interaction with a digital publication of claim 16 wherein said map section further comprises a geographic queries button, whereby said querying advertiser may customize information depicted on said map.

18. The method of recording and reporting consumer interaction with a digital publication of claim 17 wherein said report further comprises a response rates section, a usage rates section, and a display of current estimated return on investment.

19. The method of recording and reporting consumer interaction with a digital publication of claim 18 wherein said response rates section comprises a display of a consumer response rate and a consumer purchase rate.
